(19) United States
(12) Patent Application Publication
(10) Pub. No.: US 2014/0263609 A1
(43) Pub. Date: Sep. 18, 2014

(54) SYSTEM AND METHOD FOR PROVIDING INFORMATION FOR A USER OF AUTOMATED PACKAGING MACHINERY

(71) Applicants: Brianne H. Moar, Hamilton (CA); Jeffry W. Werner, Cambridge (CA)

(72) Inventors: Brianne H. Moar, Hamilton (CA); Jeffry W. Werner, Cambridge (CA)

(21) Appl. No.: 14/204,349

(22) Filed: Mar. 11, 2014

Related U.S. Application Data
(60) Provisional application No. 61/790,697, filed on Mar. 15, 2013.

(51) Int. Cl. G06F 17/30; G06K 19/00

(52) U.S. Cl. CPC G06F 17/30; G06K 19/00
USPC 235/375; 235/487

(57) ABSTRACT

The use of near field communication (NFC) data tags, or an alternative data tag, on or around automated packaging machines facilitates providing end users, or other personnel who work with such machines, with specific information about the machine and/or machine processes. The information can be specified by the machine manufacturer, specified by the end user, or a combination of both, providing added value the end user and, for example, instant support in relation to the machines and machine processes.

### TECHNICAL FIELD

This application relates generally to the field of automated packaging machinery and other automated material handling equipment and, more specifically, to a system and method for providing added value to the customers using such equipment.

### BACKGROUND

In the field of automated equipment, numerous issues can arise for the end user in relation to the set-up, servicing, adjustment, maintenance and/or upkeep for such equipment. It would be desirable to provide end users and other personnel ready access to information and assistance with such issues.

As used herein, the term “automated packaging machine” is used broadly to encompass all of the following: machines, equipment, and systems for packaging and other material and container handling applications, including all packaging, labeling, filling, conveying, and processing equipment/automation, case packers, robotic case packers, and end-of-line automation equipment, including, but not limited to, container capping systems, case forming and sealing systems, case packing systems, conveying and product handling systems, container filling systems, handle application systems, label, marking and coding systems, palletizing systems, retort and sterilization systems, robotic packaging systems, shrink sleeving systems, stretch and pallet wrapping systems, vertical bagging systems, vertical form, fill and seal systems, laner equipment, wrappers, banders, bundlers, diverters, rewinders, accumulators, cartoning equipment, packaging raw material related hoppers, blow mold systems, thermal forming systems, box/container taping systems and tray overwrapping systems.

### SUMMARY

The use of near field communication (NFC) tags, or an alternative tag, on or around automated packaging machines facilitates providing end users, or other personnel who work with such machines, with specific information about the machine and/or machine processes. The information can be specified by the machine manufacturer, specified by the end user, or a combination of both, providing added value the end user and, for example, instant support in relation to the machines and machine processes.

In one aspect, an automated packaging machine is adapted to selectively enable access to information specific to different locations on the machine. The machine includes a plurality of data tags, each data tag located at a respective specific location on the machine. Each data tag is encoded with data and is configured to enable the data to be read therefrom by a portable device. The data of each data tag includes data identifying a data retrieval location for obtaining information particular to the specific location of the data tag on the machine.

In one implementation, a control unit associated with the machine includes a wireless communication channel. In the case of each of a multiplicity of the data tags of the plurality, the encoded data includes data identifying a information storage location within a data store of the control unit.

In one implementation, the control unit includes an associated file server housing the data store, and each data retrieval location is associated with the file server.

In one implementation, the control unit is configured such that, in response to receipt of data identifying a information storage location from a portable device in session with the control unit via the wireless communication channel, information is retrieved from the file server and communicated to one or both of (i) the hand-held device via the wireless communication channel for display on a display screen of the hand-held device or (ii) to an on-machine display screen for display thereon.

Each data tag comprises an NFC data tag, an RFID data tag or a QR code data tag.

In another aspect, a system for providing information to one of a user, installer or servicer of an automated packaging machine is provided. The system includes a plurality of data tags, each data tag at a respective location on the automated packaging machine, each data tag encoded with data, and each data tag configured to enable reading by a portable device when the portable device is brought into proximity with the data tag. Each of a multiplicity of the data tags is encoded with at least one set of data that specifically pertains to its respective location on the automated packaging machine such that the at least one set of data of the data tag is not encoded on any other data tag among the multiplicity of data tags.

In one implementation, the at least one set of data of each of the multiplicity of the data tags is at least one of (1) part information specific to the location of the data tag, or a link to the same, (2) service information particular to the location of the data tag, or a link to the same, (3) machine adjustment information specific to the location of the data tag, or a link to the same or (4) a technical drawing specific to the location of the data tag, or a link to the same.

In one implementation, the part information is in the form of at least one of (1) a part number specific to the location of the data tag, (2) pricing for a part specific to the location of the data tag or (3) ordering information a part specific to the location of the data tag; or a link to the same.

In one implementation, the service information is in the form of at least one of (1) text, image, audio and/or audiovisual content regarding service specific to the location of the data tag or (2) service support information specific to the location of the data tag.

In one implementation, the machine adjustment information is in the form of text, image, audio and/or audiovisual content regarding a machine adjustment specific to the location of the data tag; or a link to the same.

In alternative implementations, each data tag is an NFC data tag, and the portable device is NFC equipped; or each data tag is an RFID data tag and the portable device is RFID equipped; or each data tag is a QR code data tag and the portable device is QR code equipped.

In another aspect, a method of utilizing an automated packaging machine involves the steps of: the automated packaging machine having a data tag at a specific location on the automated packaging machine, the data tag encoding data that is particular to the specific location; moving a portable device into proximity with the data tag, whereby the portable device obtains data that is encoded on the data tag; wherein the portable device includes a display screen, and subsequent to obtaining the encoded data, displaying on the display screen information pertaining to at least one of: (i) adjustment, maintenance or servicing of the machine, the displayed information being established in accordance with the encoded data; or (ii) training information relative to the machine, the displayed information being established in accordance with the encoded data; or (iii) ordering a replacement component for the machine, the displayed information being established in accordance with the encoded data.

In one implementation of the method, the displayed information is at least one of text, image, audio and/or audiovisual content.

In one implementation of the method, the encoded data comprises a link by which the portable device retrieves information for display.

In alternative implementations of the method, the data tag is an NFC data tag, and the portable device is NFC equipped; or the data tag is an RFID data tag and the portable device is RFID equipped; or the data tag is a QR code data tag and the portable device is QR code equipped.

In another aspect, a method of servicing an automated packaging machine involves: providing a data tag at a location on the automated packaging machine; moving a portable device into proximity with the data tag, whereby the portable device obtains encoded data that is located on the data tag; wherein the portable device includes a display screen, and subsequent to obtaining the encoded data, displaying information pertaining to servicing of the machine.

In one implementation of the method, the portable device displays an audio-visual explanation of a service procedure.

In one implementation of the method, the encoded data comprises a link by which the portable device retrieves information for display.

In another aspect, a method of ordering a replacement component for an automated packaging machine involves: providing a data tag at a location on the automated packaging machine at which a component is located; moving a portable device into proximity with the data tag, whereby the portable device obtains encoded data that is located on the data tag; wherein the portable device includes a display screen, and subsequent to obtaining the encoded data, displaying information pertaining to ordering a replacement component.

In one implementation of the method, the displayed information is at least one of a part number for the component, pricing for the component, or contact information for ordering the replacement part.

In one implementation of the method, the portable device displays a purchase order for ordering the replacement component.

In one implementation of the method, the portable device provides a purchase order submission link enabling the purchase order to be electronically submitted to a supplier.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a schematic of an automated packaging machine including a plurality of NFC tags;

FIG. 2 is a depiction of a robotic top load case/tray packer machine as one possible variation of the FIG. 1 automatic packaging machine;

FIG. 3 shows one embodiment of data tag communication system/operation;

FIG. 4 shows another embodiment of data tag communication system/operation;

FIG. 5 shows another embodiment of data tag communication system/operation;

FIG. 6 shows another embodiment of data tag communication system/operation;

FIG. 7 shows another embodiment of data tag communication system/operation;

FIG. 8 shows one, embodiment of information displayed on a display screen of a portable device as a result of a data tag read;

FIG. 9 shows another embodiment of information displayed on a display screen of a portable device as a result of a data tag read;

FIG. 10 shows another embodiment of information displayed on a display screen of a portable device as a result of a data tag read;

FIG. 11 shows another embodiment of information displayed on a display screen of a portable device as a result of a data tag read; and

FIG. 12 shows another embodiment of information displayed on a display screen of a portable device as a result of a data tag read.

### DETAILED DESCRIPTION

Near field communication (NFC) is a set of standards for smartphones and similar devices to establish radio communication with each other by touching them together or bringing them into close proximity, usually no more than a few centimeters. Communication is also possible between an NFC device and an unpowered NFC chip, called a “tag”.

NFC is a set of short-range wireless technologies, typically requiring a distance of 10 cm or less. NFC operates at 13.56 MHz on ISO/IEC 18000-3 air interface and at rates ranging from 106 kbit/s to 424 kbit/s. NFC generally involves an initiator and a target; the initiator actively generates an RF field that can power a passive target. This arrangement enables NFC targets to take very simple form factors such as tags, stickers, key fobs, or cards that do not require batteries. As used herein, the term “NFC tag” refers to any tag, sticker, key fob, card etc. that is NFC enabled and compatible. NFC peer-to-peer communication is possible in cases where both devices are powered. The NFC tags primarily contemplated herein are unpowered mechanisms, though in some cases powered devices could be used (e.g., drawing power from the power supply/line of the automated packaging machine).

As with proximity card technology, near-field communication uses magnetic induction between two loop antennas located within each other's near field, effectively forming an air-core transformer. It operates within the globally available and unlicensed radio frequency ISM band of 13.56 MHz. Most of the RF energy is concentrated in the allowed ±7 kHz bandwidth range, but the full spectral envelope may be as wide as 1.8 MHz when using ASK modulation.

In passive communication mode, the initiator device provides a carrier field and the target device answers by modulating the existing field. In this mode, the target device may draw its operating power from the initiator-provided electromagnetic field, thus making the target device a transponder. In active communication mode, both initiator and target device communicate by alternately generating their own fields. A device deactivates its RF field while it is waiting for data. In this mode, both devices typically have power supplies.

Referring to the system of FIG. 1, an exemplary automated packaging machine 10 (e.g., of any of the types previously mentioned) is shown. The machine includes, by way of example, a control interface 12 (e.g., with display screen and input means etc.), a power interface 14, a set of access doors, gates our guards 16 for limiting access to a portion of the machine, but movable to permit access, and various other components such as one or more adjustment devices 18, one or more motors 20, one or more robotic mechanisms 22, one or more conveying or moving systems 24 and/or one or more control boxes 26 etc. Each such component is shown with a corresponding or respective NFC tag 30a-30h mounted thereon or in proximity thereto.

In one embodiment, the illustrated system provides information to one of a user, installer or servicer of the automated packaging machine by providing the plurality of NFC tags 30a-30h at multiple respective locations on the automated packaging machine 10, with each NFC tag 30a-30h encoded with data and each NFC tag configured for interrogation by a NFC equipped portable device 40 when the portable device is brought into proximity with the NFC tag. The NFC equipped portable device may, for example, be an NFC equipped phone, tablet, computer or other device. A multiplicity of the NFC tags (e.g., 30a, 30c, 30g and 30h), and potentially all of the tags, are encoded with at least one set of data that specifically pertains to its respective location on the automated packaging machine such that the at least one set of encoded data of the NFC tag is not encoded on any other NFC tag among the multiplicity of NFC tags (e.g., the tag 30c includes a set of encoded data that is not included on tag 30g, and visa versa, though there may be a partial overlap of encoded data). In this manner, each NFC data tag may be configured for a specific purpose and function that is tied to the location of the tag on the machine.

In one implementation, the at least one set of data encoded on each of the multiplicity of the NFC tags is at least one of (1) part information specific to the location (e.g., part number, part reordering information, part troubleshooting information and/or alternative component information), or a link to the same, (2) service information particular to the location, or a link to the same, (3) machine information specific to the location (e.g., adjustment information, historical information, series information), or a link to the same or (4) a technical drawing specific to the location, or a link to the same. The part information may, for example, be in the form of one or more of (1) a part number specific to the location, (2) pricing for a part specific to the location, (3) contact information for ordering a part specific to the location, (4) a technical drawing for a part specific to the location or (5) machine related information specific to the part. The service information may, for example, be in the form of at least one of (1) text, image, audio and/or audiovisual content regarding service specific to the location or (2) contact information for service support specific to the location. The machine information may be in the form of text, image, audio and/or audiovisual content regarding machine adjustments specific to the location or a reminder to refill product consumables on equipment. As explained in more detail below, the link may take the form a full web based URL, or may be a designation of a file location (e.g., within a local file server).

The use of NFC data tags, or alternative forms of data tags, also provides various advantageous methods.

For example, a method of adjusting operation of an automated packaging machine involves: providing an NFC tag at a location on the automated packaging machine at which one or more adjustments can be made; moving an NFC equipped portable device into close proximity with the NFC tag, whereby the NFC equipped portable device obtains data that is encoded on the NFC tag; wherein the NFC equipped portable device includes a display screen that, in response to obtaining the tag data, displays information pertaining to adjustment of the machine. The displayed information may, for example, be at least one of text, image, audio and/or audiovisual content regarding machine adjustment, or a link to any one of the same. The NFC equipped portable device may display an audio-visual explanation of an adjustment procedure.

In another example, a method of servicing an automated packaging machine involves: providing an NFC tag at a location on the automated packaging machine; moving an NFC equipped portable device into close proximity with the NFC tag, whereby the NFC equipped portable device obtains data that is encoded on the NFC tag; wherein the NFC equipped portable device includes a display screen that, in response to obtaining the encoded information, displays information pertaining to servicing of the machine. The displayed information may, for example, be at least one of text, image, audio and/or audiovisual content regarding machine servicing, or a link to one or more of the same. The NFC equipped portable device may display an audio-visual explanation of a service procedure.

In a further example, a method of inquiring about replacement components for an automated packaging machine involves: providing an NFC tag at a location on the automated packaging machine at which a component is located; moving an NFC equipped portable device into close proximity with the NFC tag, whereby the NFC equipped portable device obtains data that is encoded on the NFC tag; wherein the NFC equipped portable device includes a display screen that, in response to obtaining the encoded information, displays information pertaining to inquiring about history and information for components. The displayed information may, for example, be at least one of a part number for the component, product or part history, pricing for the component, contact information for ordering the replacement part, or a link to one or more of the same. The NFC equipped portable device may display specific information about the part, component or machine, as well as the purchase order for ordering the replacement components, and provide a purchase order submission link enabling the purchase order to be electronically submitted to a supplier.

It is recognized that in the system and methods described above, the NFC data tags could, alternatively, be another form of identification tag such as an RFID tag or a QR code tag, and the NFC equipped portable device could, alternatively be, RFID equipped or QR code equipped.

Exemplary types of data on the NFC tags would be links to one or more of manuals (e.g., operator, service or installation), help forums/blogs, signal reminders to refill product installation information/videos, troubleshooting media, cyclical/rate information, history of equipment, part replacement, email/contact data, engineering drawings, product information, company information, access to internal login portals or equipment optimization suggestions.

It is also possible to tap an NFC equipped phone to the NFC tag and have a phone number pop up—so the user just needs to press send—to make a call for help or support.

Exemplary types of media that may be retrieved based upon the tag data include video file links to youtube, pdf's, jpeg's, png, tiff, bmp, wmv, mpg, Word documents, Excel spread sheets, links to the web such as linkedIn & twitter, vob, mpg4, pix, eps, gif, html or htm.

Exemplary NFC equipped devices that could be used include phones, tablets, laptops, computers, any media devices that are or may be released that have NFC capabilities.

Referring to FIG. 2, an exemplary robotic top load case packer 50 is shown with an interface 52 including an NFC tag 60a, access doors 54 including an NFC tag 60b and conveyor 56 including an NFC tag 60c.

Referring now to FIG. 3, one exemplary embodiment of an NFC tag communication system/operation is shown, where an NFC data tag 70 located on an automated packaging machine is interrogated or polled by a NFC equipped mobile phone 72 (e.g., by bringing the phone into contact or close proximity with the NFC data tag), which results in the data encoded on the tag being retrieved by the phone over the near field communication path 74. The retrieved data may be a web-based URL that is automatically loaded into the internet address field or navigation tool of the phone's internet access engine or platform. The phone accesses the Internet 76 via cellular communication path 78, and specifically a web server 80 associated with the URL. The URL designates specific information/content on the web server (e.g., a machine manual, machine drawings, training video or photos) that is downloaded to the phone for viewing on the display of the phone.

FIG. 4 illustrates another embodiment an NFC tag communication system/operation is shown, where an NFC data tag 70 located on an automated packaging machine is interrogated or polled by a NFC equipped mobile phone 72 (e.g., by bringing the phone into contact or close proximity with the NFC data tag), which results in the data encoded on the tag being retrieved by the phone over the near field communication path 74. The retrieved data may be a web-based URL that is automatically loaded into the internet address field or navigation tool of the phone's internet access engine or platform. In this embodiment, the phone does not have access to a cellular network, as may be common in the facilities within which many types of automated packaging machines are used. Accordingly, the phone uses a wireless network 82 to access the Internet 76 (e.g., through a wireless router 84) and the web server 80 associated with the URL. In one implementation of this arrangement, access to the wireless network may be via an encrypted key that must be pre-loaded onto the mobile phone 72 (or other portable device). In this manner, on-site control (e.g., personnel at the site of the automated packaging machine) can control who is able to access the data by reading the NFC tags. In another implementation, the encrypted key could be encoded as part of the data of the NFC tag.

FIG. 5 shows another embodiment in which the data to be retrieved is located on a local filed server 90, rather than an Internet based web server. In this embodiment, an NFC data tag 70 located on an automated packaging machine is interrogated or polled by a NFC equipped mobile phone 72 (e.g., by bringing the phone into contact or close proximity with the NFC data tag), which results in the data encoded on the tag being retrieved by the phone over the near field communication path 74. The mobile phone 72 access the local file server 90 via a wireless network 92 through any suitable wireless access point 94. The data retrieved from the tag may be a local URL that designates a storage location within the file server, causing the file server to access information/content at the storage location, which is downloaded to the mobile phone 72 for viewing on the phone's display. As with the embodiment of FIG. 3, wireless network access may be controlled by an encrypted key. With respect to the local file server 90, in one example an automated packaging facility may have single file server that stores information/content for multiple machines, each having multiple tags. However, in another embodiment, the file server 90 may be embodied as part of the automated packaging machine itself (e.g., within a control box that is local to, and part of the automated packaging machine).

The embodiment of FIG. 6 is similar to that of FIG. 5, except that the automated packaging machine includes a remote machine display screen 96 (e.g., a user interface screen), and the tag reading operation causes the stored content/information of the file server 90 to be pushed to the machine display screen 96 for display. Because the machine display 96 will typically be much larger than the display of the mobile phone, this arrangement facilitates more useful viewing of certain types of content/information, such as technical drawings. When the mobile phone 72 access the file server 90, the mobile phone commands the file server to push the content/information to the display 96. In this regard, in one embodiment the data encoded on the NFC tag may include data that is configured to cause the phone to make this command. In another embodiment, the data stored on the file server at the file location that is accessed may itself include the command that causes the push to machine display 96 to take place.

The embodiment of FIG. 7 is similar to that of FIG. 6, except that a proprietary handset 98 is used in place of a mobile phone. The purpose of providing a proprietary handset is to eliminate the requirement for an operator to have a cellular phone present on the factory floor and to increase security level of the area. The proprietary handset can be configured to communicate to the NFC tag whereas a standard cellular phone will not be capable (e.g., through some form of encrypted key or link). This arrangement reduces the chance of unauthorized access of the data contained on, or linked to through, the NFC data tags.

Reference is now made to FIGS. 8-12 for exemplary displays appearing on a portable device (e.g., mobile phone) after reading of a data tag. In particular, FIG. 8 shows a display of the URL loaded into the navigation tool of the phone, with a query made as to whether the phone should proceed to access the URL. FIG. 9 shows a display screen at which a machine manual is being downloaded for viewing, and FIG. 10 shows a display screen at which a downloaded manual is actually being viewed on the display screen. FIG. 11 shows an embodiment in which the retrieved data of an NFC tag links to a video (e.g., via YouTube) for viewing. The video may, for example, show any of proper machine operation (e.g., for training) or proper procedure for a particular service, maintenance or adjustment operation of the machine. FIG. 12 shows an embodiment in which the retrieved data of an NFC tag results in production of a communication message (e.g., e-mail) through which parts can be requested).

It is to be clearly understood that the above description is intended by way of illustration and example only, is not intended to be taken by way of limitation, and that other changes and modifications are possible.

What is claimed is:

1. An automated packaging machine adapted to selectively enable access to information specific to different locations on the machine, comprising:
a plurality of data tags, each data tag located at a respective specific location on the machine, each data tag encoded with data, each data tag configured to enable the data to be read therefrom by a portable device, wherein data of each data tag includes data identifying a data retrieval location for obtaining information particular to the specific location of the data tag on the machine.

2. The automated packaging machine of claim 1, further comprising:
a control unit associated with the machine, the control unit including a wireless communication channel, wherein for each of a multiplicity of the data tags of the plurality, the encoded data includes data identifying a information storage location within a data store of the control unit.

3. The automated packaging machine of claim 2 wherein the control unit includes an associated file server housing the data store, and each data retrieval location is associated with the file server.

4. The automated packaging machine of claim 3 wherein the control unit is configured such that, in response to receipt of data identifying a information storage location from a portable device in session with the control unit via the wireless communication channel, information is retrieved from the file server and communicated to one or both of (i) the hand-held device via the wireless communication channel for display on a display screen of the hand-held device or (ii) to an on-machine display screen for display thereon.

5. The automated packaging machine of claim 1 wherein each data tag comprises an NFC data tag, an RFID data tag or a QR code data tag.

6. A system for providing information to one of a user, installer or servicer of an automated packaging machine, the system comprising:
a plurality of data tags, each data tag at a respective location on the automated packaging machine, each data tag encoded with data, and each data tag configured to enable reading by a portable device when the portable device is brought into proximity with the data tag;
wherein each of a multiplicity of the data tags is encoded with at least one set of data that specifically pertains to its respective location on the automated packaging machine such that the at least one set of data of the data tag is not encoded on any other data tag among the multiplicity of data tags.

7. The system of claim 6 wherein the at least one set of data of each of the multiplicity of the data tags is at least one of (1) part information specific to the location of the data tag, or a link to the same, (2) service information particular to the location of the data tag, or a link to the same, (3) machine adjustment information specific to the location of the data tag, or a link to the same or (4) a technical drawing specific to the location of the data tag, or a link to the same.

8. The system of claim 7 wherein part information is in the form of at least one of (1) a part number specific to the location of the data tag, (2) pricing for a part specific to the location of the data tag or (3) ordering information a part specific to the location of the data tag.

9. The system of claim 7 wherein service information is in the form of at least one of (1) text, image, audio and/or audiovisual content regarding service specific to the location of the data tag or (2) service support information specific to the location of the data tag.

10. The system of claim 7 wherein machine adjustment information is in the form of text, image, audio and/or audiovisual content regarding a machine adjustment specific to the location of the data tag.

11. The system of any of claim 6 wherein:
each data tag is an NFC data tag, and the portable device is NFC equipped; or
each data tag is an RFID data tag and the portable device is RFID equipped; or
each data tag is a QR code data tag and the portable device is QR code equipped.

12. A method of utilizing an automated packaging machine, the method comprising:
the automated packaging machine having a data tag at a specific location on the automated packaging machine, the data tag encoding data that is particular to the specific location;
moving a portable device into proximity with the data tag, whereby the portable device obtains data that is encoded on the data tag;
wherein the portable device includes a display screen, and subsequent to obtaining the encoded data, displaying on the display screen information pertaining to at least one of:
(i) adjustment, maintenance or servicing of the machine, the displayed information being established in accordance with the encoded data; or
(ii) training information relating to the machine, the displayed information being established in accordance with the encoded data; or
(iii) ordering a replacement component for the machine, the displayed information being established in accordance with the encoded data.

13. The method of claim 12 wherein the displayed information is at least one of text, image, audio and/or audiovisual content.

14. The method of claim 12 wherein the encoded data comprises a link by which the portable device retrieves information for display.

15. The method of claim 12 wherein:
the data tag is an NFC data tag, and the portable device is NFC equipped; or
the data tag is an RFID data tag and the portable device is RFID equipped; or
the data tag is a QR code data tag and the portable device is QR code equipped.

16. A method of servicing an automated packaging machine, the method comprising:
providing a data tag at a location on the automated packaging machine;
moving a portable device into proximity with the data tag, whereby the portable device obtains encoded data that is located on the data tag;
wherein the portable device includes a display screen, and subsequent to obtaining the encoded data, displaying information pertaining to servicing of the machine.

17. The method of claim 16 wherein the portable device displays an audio-visual explanation of a service procedure.

18. The method of claim 16 wherein the encoded data comprises a link by which the portable device retrieves information for display.

19. A method of ordering a replacement component for an automated packaging machine, the method comprising:
providing a data tag at a location on the automated packaging machine at which a component is located;
moving a portable device into proximity with the data tag, whereby the portable device obtains encoded data that is located on the data tag;
wherein the portable device includes a display screen, and subsequent to obtaining the encoded data, displaying information pertaining to ordering a replacement component.

20. The method of claim 19 wherein the displayed information is at least one of a part number for the component, pricing for the component, or contact information for ordering the replacement part.

21. The method of claim 19 wherein the portable device displays a purchase order for ordering the replacement component.

22. The method of claim 21 wherein the portable device provides a purchase order submission link enabling the purchase order to be electronically submitted to a supplier.
